(19) United States
(12) Patent Application Publication
(10) Pub. No.: US 2005/0202392 A1
(43) Pub. Date: Sep. 15, 2005

(54) WEB SERVICE API FOR STUDENT INFORMATION AND COURSE MANAGEMENT SYSTEMS

(76) Inventors: J. Vance Allen, Denver, CO (US); Brian Burson, Highland Ranch, CO (US); Michael Van Cleave, Parker, CO (US); Mark Resmer, Larkspur, CO (US)

Correspondence Address: SNELL & WILMER;ONE ARIZONA CENTER, 400 EAST VAN BUREN, PHOENIX, AZ, 850040001, US

(21) Appl. No.: 10/906,033

(22) Filed: Jan. 31, 2005

Related U.S. Application Data
(60) Provisional application No. 60/540,815, filed on Jan. 30, 2004.

(51) Int. Cl. G09B 7/00; G09B 19/00

(52) U.S. Cl. 434/362; 434/118

(57) ABSTRACT

Automated data exchange between a student information system and a course management system using an application programming interface that is directly exposed to the student information system as a web-service is disclosed. Submission of a new user record, enrollment of a user in a course, or changing user or course information triggers automatic data synchronization between the student information system and the course management system. The application programming interface provides single sign-on and bidirectional synchronization capabilities as well as real-time and asynchronous batch processing capabilities. The application programming interface supports XML, flat file, and web services processes and incorporates the IMS Enterprise v1.1 Specification standards.

### CROSS-REFERENCE TO RELATED APPLICATION

This application claims benefit from and priority to U.S. Provisional Patent Application Ser. No. 60/540,815, filed Jan. 30, 2004, which is hereby incorporated by reference in its entirety.

### FIELD OF INVENTION

The invention generally relates to an application programming interface which provides improved automated data exchange and processing between course management systems and student information systems through the use of web services, information management standards HTTP, SOAP, and XML.

### BACKGROUND OF INVENTION

Online courses, sometimes known as “E-learning,” have become an essential part of higher-education institutions with some institutions offering tens of thousands of courses to millions of students. Educators are constantly seeking improved data exchange and system integration to keep pace with the higher number of courses being offered to help attract and retain students. Two systems of particular importance to the efficient administration of these learning institutions are the client's student information system (SIS) and the host/server course management system (CMS).

Current application programming interfaces (“API”) are typically internal to the CMS and often facilitate only basic data exchange with the SIS. Existing CMS systems do not expose internal APIs to allow client users to directly perform listed operations; rather, users typically request those operations through a web-based interface. Existing systems often rely on a single file format and a batch parser for processing data between applications and systems. Use of a single file format does not accommodate full integration with other applications and systems using other formats. Batch parsers provide only limited processing capabilities, generate exceptionally large files and provide little or no user control over when the parser runs. Existing systems typically do not support automated import, export, and synchronization of user activity, user roles, student enrollment, student grades, course catalog information and other similar information between SIS and CMS systems.

Existing systems also typically include excessive manual operations and user interaction to process data between applications, while providing few tools for integrating or customizing desired functions and features. Managing and processing student and course data often requires excessive work hours and system training. Furthermore, institutions or clients often maintain and integrate numerous third party and proprietary software applications. For example, previous systems often require that students, system administrators or other users enter student data through a web page enrollment application or by manually inputting or scanning data supplied on mailed applications and forms. SIS and CMS systems often include functional overlap such as registration and grading which are common to both systems. Partial or inadequate integration of these systems and other applications results in unnecessary “shadow data,” that may not be adequately maintained or updated along with the original or other duplicate data.

The terms “client” and “server” are used to refer to a computer's general role as a requester of data (the client) or provider of data (the server). An application programming interface (API) is defined as a set of routines, protocols, and tools for building software applications. Using APIs, a program can open windows, files, and message boxes and perform more complicated tasks by passing a single instruction. APIs allows programmers to develop programming for single instruction routines using API programming building blocks and software development kit (SDK) tools. Most operating environments such as, for example, MS-Windows®, provide APIs so that programmers can write applications consistent with the operating environment. Although APIs are designed for programmers, users benefit as well because all programs using a common API have similar interfaces. Similar interfaces make it easier for users to learn new programs, thereby reducing processing and training time.

Microsoft BizTalk Server™ is a software application, which is typically loaded on a host server that serves to integrate systems by establishing secure trading partner relationships between different operating systems, programming models, and/or programming languages. The BizTalk Server infrastructure exchanges business documents among applications within or across a network. BizTalk Server includes graphical tools useful to application developers in modeling and implementing integration schemes.

APIs incorporate various protocols or document formats. Extensible Markup Language (“XML”) for web documents is one format that allows designers to create customized tags, enabling the definition, transmission, validation, and interpretation of data between applications and between systems. An XML document includes a hierarchy comprised of elements that have contents and attributes. XML web services are fundamental building blocks in distributed computing on the Internet and a popular platform for application integration. XML web services allow applications to communicate and share data over the Internet, regardless of operating system, device, or programming language. Multiple XML web services are used to construct applications from various sources, independent of the location or method of implementation of the individual source applications or systems. XML web services provide detailed descriptions of systems to allow users to build client applications. These detailed descriptions are usually provided in an XML document called a Web Services Description Language (“WSDL”) document. XML web services are also registered using a Universal Discovery Description and Integration (“UDDI”) so that potential users can easily find them. Microsoft® NET is one popular XML web services platform. The Microsoft® NET platform provides developers with tools to create XML web services and to stitch the services together.

XML web services typically use a standard web protocol such as, for example, the Simple Object Access Protocol (“SOAP”). SOAP is a specification that defines the XML format for messages. A SOAP message includes a well-formed XML document fragment enclosed in SOAP elements.

The eLearning community has sought to establish standards for distributed learning content and environments. The IMS Global Learning Consortium provides such standards by defining the technical specifications for interoperability of applications and services in distributed learning. The IMS standards identify, for example, the source of a document, user details, course details, and enrolled course user membership. A root element including comments, properties, person, group, and membership data is part of all Enterprise XML instances formatted according to standards set forth in the IMS Enterprise Specification. The IMS specifications define XML-based specifications for exchanging learning content and information about learners among learning system components. The IMS specifications and standards are available at the http://www.imsproject.org web-site which is incorporated in its entirety herein by reference. The IMS Enterprise Information Model defines a standardized set of structures that can be used to exchange data between different systems. These structures standardize data bindings to allow software developers to create instructional management processes that interoperate across independently developed systems. Exemplary classes of enterprise applications supported by the IMS model are Training Administration, Student Administration, Library Management, and Human Resource systems. The scope for IMS specifications, broadly defined as “distributed learning,” includes both online (web-based learning) and off-line (CD-ROM) settings in various educational environments (e.g., school classroom, university), in a corporate or government training setting, or at home.

One exemplary IMS specification, the Reusable Definition of Competency or Educational Objective (RDCEO) specification, provides a means to create common understandings of competencies as part of a learning plan or as learning outcomes. Similarly, the IMS Content Packaging Specification provides the functionality to describe and package course materials or courses into interoperable, distributable packages.

Most existing systems currently exchange course information in one of three ways: manual tools in an administrative user interface, a batch flat-file process for creating new course shells, or batch course duplicating with a flat-file API process. These current course import tools do not provide a sufficient standards-based API or automated data exchange. The current data exchange processes often require significant start-up support and user action to launch, and can necessitate extensive support to troubleshoot. Increased adoption of IMS specifications and standards will allow for greater integration of distributed learning environments and content from multiple authors. Increased feature flexibility and integration of administrative applications is needed to better deliver and support E-learning courses and online student services.

Accordingly, there is a need for a system which provides real-time and asynchronous processing, improved accuracy and error-handling, customization capabilities and support for machine-to-machine communication and data exchange in multiple formats. There is a need for improved integration of, and programming flexibility for, SIS and CMS systems allowing administrators to better manage user roles, student enrollment, course catalogs, user activity, student grade data and course catalog information between various client and server applications and systems. Automated data exchange is needed to obviate manual data input and process requests and to reduce administrative overhead by removing the need for entering data in more than one system.

### SUMMARY OF INVENTION

The invention increases administrative efficiency through improved data exchange set-up, troubleshooting, and programming tools. The invention provides a full standards-based application programming interface (“API”) including features and functions for improved management and exchange of data related to, for example, student profiles, courses, course catalogs, grades, user and activity data, and system user roles. The invention further provides course copy services, grade and activity exports and course property export options.

The invention includes, in one embodiment, an API for automating the import and export of data into or from various systems. This data is transmitted using an import/export parser, a batch flat-file process, and XML or a web services (SOAP protocol). In an exemplary data exchange, batch flat-files are sent to an FTP folder on a host server, the file is then translated into XML and communicated to the API also using an FTP folder. The invention includes use of web services to support machine-to-machine communication between an SIS and CMS host server using SOAP (Simple Object Access Protocol) to communicate information from one system to another, including processing of student enrollment or course information requests and error handling.

The system includes, in one embodiment, a single sign-on feature with which students, faculty or administrators can access multiple or all on-campus systems and applications (e.g., library and SIS) with a single entry of user credentials. Enhanced messaging features allow administrators to be more responsive to students needs, for example, with more timely addition of needed course sections, processing of applications and enrollments, and transferring grade data to the SIS. Integration of multiple applications and systems through the API reduces administrative time by reducing or eliminating redundant data entry and data transfer processes.

The invention includes multiple processing mechanisms or capabilities including, for example, flat file, XML flat file, web services, and bulk import via flat file formats. The API enables bi-directional synchronization of SIS client data with a CMS central repository.

### BRIEF DESCRIPTION OF THE DRAWINGS

Additional aspects of the invention will become evident upon reviewing the non-limiting embodiments described in the specification and the claims taken in conjunction with the accompanying figures, wherein like reference numerals denote like elements, and

FIG. 1 is a block diagram illustrating an exemplary system according to one embodiment of the invention; and

FIG. 2 is a flowchart illustrating an exemplary web service process according to one embodiment of the invention.

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In general, the invention provides an improved application programming interface (“API”) for integrating and customizing eLearning applications and systems, including student information systems (“SIS”) and course management systems (“CMS”). The API facilitates data exchange between CMS and SIS systems using IMS Enterprise Specification 1.1 compliant XML documents, and delimited flat file formats. The API provides batch, XML and web services processing options using a standard IMS Enterprise specification v1.1 as the standard for communication. Data (e.g., user data) is created, imported, exported or updated, for example, when users enroll in a course. The API submits student, faculty, or other user data to the CMS using a SOAP web service call (process IMS request), a delimited file type, or an XML document via FTP. The API retrieves data and submission results via FTP or via a call-back web service and provides confirmation and error messages to administrators and users, for example, by email.

The combined SIS and API architecture provides for real-time as well as asynchronous bulk (batch) request processing. For example, for a single transaction, the API transforms the Enterprise document and forwards it to a processing channel to be immediately processed. During asynchronous processing, requested transactions (both single and batch requests) may be queued to process at low system-utilization times. For example, multiple simultaneous transactions are transformed and sent to a bulk process relay channel to be processed later during an operation service window.

The API supports multiple mechanisms or document formats, such as flat file, XML flat file, batch files and web services. The API may receive documents by HTTP or FTP. In one embodiment, the API is primarily a machine to machine interface with little or no need for user interaction or a user interface. The API provides machine-readable error messaging for failed XML and web services requests. One embodiment of the invention includes Microsoft BizTalk Server software to facilitate communication between and integration of various systems and applications.

The API includes both orthogonal functions/features (e.g., fixed, one-way) and flexible or customizable functions/features which may be modified or supplemented and tested. The API includes SDK tools such as code examples, documentation for each of the code examples, a defined test environment, and other tools. Exemplary SDK documentation includes IMS specifications, sample IMS Enterprise v1.1 XML and XML schema, call-back web service sample code, a list of machine readable error codes, a description of system functions, the XML schema for each function, and the required parameters for invoking each function or feature. The SDK further includes a test environment that allows programmers to test batch, XML or web services requests against a production environment.

One embodiment of the invention utilizes web services, XML, XSL/XSLT, SOAP, IMS standards, SCORM and Microsoft NET. These combined applications and technologies provide an open, distributable, flexible, customizable and extensible API architecture.

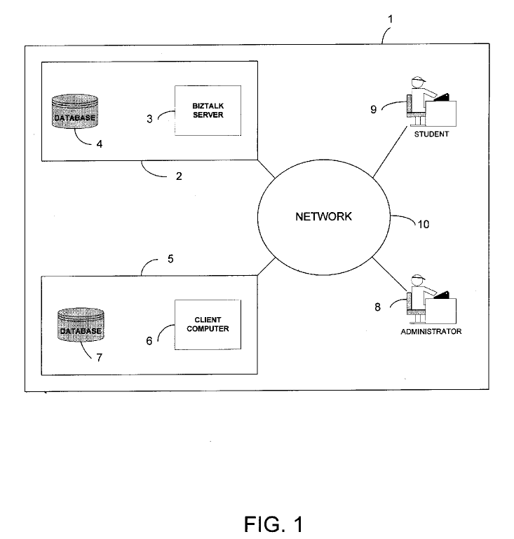

Turning now to the drawings, FIG. 1 illustrates an exemplary data exchange system 1 comprising, in one embodiment, a host CMS system 2 including a host server 3 and a database 4, a client SIS system 5 including a client computer 6 and a database 7, with client SIS system 5 communicating with host system 2 through a network 10. System 1 further includes an administrator user computer 8 and student user computer 9 communicating with client SIS system 5 and/or host system 2 through network 10.

In one embodiment, host server 3 includes Microsoft BizTalk Server™ software for connecting and/or integrating multiple systems and applications. Client SIS system 5 and host system 2 automatically communicate over network 10 to synchronize data between databases 4 in host CMS system 2 and database 7 client SIS system 5. For example, an administrator at administrator computer 8 submits demographic or other student profile information of a newly enrolled student to client computer 6. At a predetermined time or following certain trigger events, client computer 6 synchronizes the new student data with host CMS system 2. Host system 2 may function as a central data repository for multiple client computers 6 at different locations, for example, at geographically diverse universities.

In another embodiment, host CMS system 2 includes software applications accessible by users at administrator computer 8 or student computer 9 through network 10 and/or client computer 6. For example, in one embodiment, host server 3 includes an application programming interface and an email engine application such as Rocbox produced by ecollege.com. It is understood that any of the software applications or modules discussed herein may be loaded on and/or accessed by any computer or server discussed herein.

Multiple host servers 3 may be clustered to ensure reliability and to provide a load balancing. In one embodiment, all XML documents and transactions are logged and archived (e.g., for forty-five days) in database 4 to facilitate data recovery. Host CMS system 2 provides for a default data dump action of all files that have been stored in data dump directories for more than, for example, forty-five days. System administrators may change the data dump defaults as a whole or its application to various files.

Host CMS system 2 includes API modules that are exposed to client SIS system 5 and client system users through web services providing direct access to the API for automated user creation, user enrollment, course shell creation, course duplication, course property modification, course listing export, attendance check export, final grade export, and the like. Client programmers may write to the API through an SDK including sample code, documentation, and a test environment.

In configurations in which host CMS system 2 serves multiple client SIS systems 5, host server 3 appropriately segregates and controls access to data submitted and requested by each client institution. Host CMS system 2 automatically performs periodic synchronization procedures with client SIS systems 5 at each of the multiple institutions. To implement API integration with existing systems, data in existing applications and/or third party applications may be converted into a desired format and system and data files mapped into the API XML schema. This data conversion and file mapping allows the API to support legacy or existing parser systems.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: course data; student data; content data; institution data; and/or like data useful in the operation of the present invention. As those skilled in the art will appreciate, user computers 8-9 may include an operating system (e.g., Windows NT, 95/98/2000, OS2, UNIX, Linux, Solaris, MacOS, etc.) as well as various conventional support software and drivers typically associated with computers. User computers 8-9 may include any suitable personal computer, network computer, workstation, minicomputer, mainframe or the like. User computers 8-9 can be in a home or educational institution environment with access to a network. In an exemplary embodiment, access is through a network or the Internet through a commercially-available web-browser software package.

As used herein, the term “network” shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant (e.g., Palm Pilot®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. The invention may be implemented with TCP/IP communications protocols or with IPX, Appletalk, IP-6, NetBIOS, OSI or any number of existing or future protocols. If network 10 is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to network 10 via data links which include, for example, a connection to an Internet Service Provider (ISP) over a local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that network 10 may be implemented as other types of networks, such as an interactive television (ITV) network. Moreover, the system contemplates the use, access, viewing, copying, sale or distribution of any information, goods or services over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The invention contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets. Furthermore, the security information may restrict/permit only certain actions such as accessing, copying, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

Firewalls may be deployed between various system components to further enhance security. A firewall may include any hardware and/or software suitably configured to protect system components and/or enterprise computing resources from users of other networks. Further, a firewall may be configured to limit or restrict access to various systems and components behind the firewall for web clients connecting through a web server. The firewall may reside in varying configurations including Stateful Inspection, Proxy based and Packet Filtering among others. The firewall may be integrated within a web server or any other system components or may further reside as a separate entity.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

The present invention may be described herein in terms of functional block components, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “user”, “administrator”, “student”, “educator”, “institution”, “participant”, “client” or “campus” may be used interchangeably with each other, and each shall mean any person, entity, machine, hardware, software or business. Each participant is equipped with a computing device in order to interact with the system. Exemplary computing units include personal computers, laptops, notebooks, hand held computers, set-top boxes, cellular telephones, and the like. Applications may be hosted at a computing center such as a main frame computer. The computing center may be implemented in other forms, such as a mini-computer, a PC server, a network of computers located in the same of different geographic locations, or the like.

In an exemplary implementation, the API is implemented as computer software modules loaded onto a host computing center. The API is exposed to users as a web service, providing for primarily automated machine to machine communication with minimal or no need for user interface. Alternatively, the client computer may require additional software to support use of the API.

As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the single or multiple steps as illustrated and described may be combined or separated into single steps, webpages and/or windows.

System user interfaces may include any conventional web browser application features and menu functions. Any number of features represented by different tabs, list item, links and the like, may be accessible from any number of interactive screens. Various display fields and standard menu or action links may likewise be cross-linked or associated with any displayed information, field, or other links. Entry of information in any of the described fields may be accompanied by a summary or confirmation page. In a web-based embodiment, the user interface includes conventional browser and file menu options such as, for example, find, browse, edit, format and view functions. Auto-completion may be enabled for certain fields and defaults for others may be preset or user defined. For example, the current date may be automatically entered in a date field, yet still be altered by a user. Tabs, icons, list items, menu items, radio buttons, etc. may be used interchangeably and may appear on more than one screen and may be fully customizable, for example, as to appearance, order, number, title, contents, cross-references, and the like. Any window, screen, or document present on the system may be exported, printed, emailed, or saved. Passwords may be required for access at any given system level or feature providing increased security or privacy.

Data searches may be conducted with either full or partial field entries (e.g., the first three letters of a course name or course code). Additional search options or searchable categories may be provided under an “Advanced Search” option including fields for user demographics, course name, instructor, date or other searchable types of information used in the art.

The API enables users to automatically import, export, synchronize, update, or otherwise request the exchange of data between SIS and CMS systems. To facilitate web import services, an institution may need to expose a virtual directory (e.g., https://www.anyclient.com/ecollege/sis.asmx) and a web service method (e.g., https://www.anyclient.com/processimsresponse). For example, client directory and web service URLs are submitted to the host system during setup. The API automatically imports or adds new users to an enroll-able area when a new user record is submitted. The system automatically checks all submitted batch files for file formatting issues and provides for resubmission of enrollment requests for a predetermined period, if a course is not yet available. This allows for courses to be set up and duplicated on an ongoing basis. Exemplary formatting and validation issues include: correct file format, number of columns, validates against xsd, unique user names, valid email, and non-zero passwords. The API allows administrators to view file submittal status and the estimated time remaining to complete the processing of a given request. Administrators may use the API to, for example, create course shells, duplicate courses, modify course properties, export course listings, export final grades, export attendance and activity reports, and test batch, XML or web services requests against the production environment, and to purge temporary files.

A user exports data by submitting a request XML file to an export folder via FTP. The request is queued and the API application extracts the data. The API places the data in a file and places the file in a datadump directory. The system then confirms the data export to the user with an email notification. A user may use various system filters or parameters to retrieve a particular data set. For example, a user may request information on new or current users, or on course enrollment changes by node, role, term or course. Administrative system users can create and update course catalogs and update or extract grades and course completion information.

Users may also initiate a process export request by, for example, inputting appropriate credentials for the document to be exported and receiving a tracking ID. Users may submit the credentials and tracking ID to obtain an export status report. Similarly, the credentials and tracking ID may be submitted to export the enterprise document with comments. Additionally, a process export response (call-back) may be used to export the enterprise document with comments.

One embodiment of the invention provides a Microsoft Excel template for accessing the API to import and display XML data from an XML Web Services interface to the export functionality of the API. The XML data may then be reviewed, modified, and/or approved and subsequently sent to the client Student Information System. For example, a user enters required parameters into an Excel template and initiates a web services data extraction or export request. After the web service accepts and processes the data extraction request, the requested XML data is imported into the Excel spreadsheet.

In an exemplary system process, the SIS calls upon the API to export a course listing including a list of all course properties for a designated group of courses in order to match up course listings with SIS course listings, or to create a source course file for future term duplication. The course listings are then exported in a batch flat-file, XML or web services format. In another exemplary system process, the API is used to create a new user profile including user role types and to enroll the user. The API assigns an enroll-able area based on user roles and other traits and then logs and reports user enrollment.

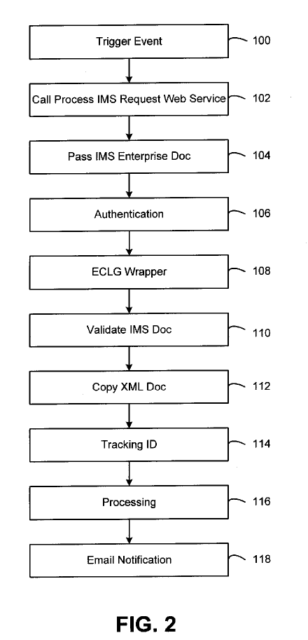

FIG. 2 illustrates an exemplary import of a web services request or Process IMS Request process according to one embodiment. A preprogrammed trigger event causes the client SIS system to automatically generate a request to the host server, for example, in the form of an XML enterprise document via FTP or HTTP (step 100). Exemplary trigger events include the submission of a new user record with a course enrollment or addition of a new user to a course in a new enroll-able area in the SIS. The client request includes a transaction tracking identifier and client or user credentials. The tracking ID and credentials are used in checking the status of a document and estimated time to process. The API may also retrieve a processed document upon entry of the credentials and tracking ID, returning the enterprise document with comments. Comments are a short sentence or sentences that describe the success or failure of the processing of that record. An additional process IMS response (call-back) feature may also be used to obtain the enterprise document with comments. The client SIS system request calls the Process IMS Request web service (step 102) and passes in the IMS Enterprise document with the user credentials embedded in the HTTPS header. (step 104) The web service authenticates the request by extracting the user name and password from the HTTPS header and making a call to the client SIS system database to validate the user credentials. (step 106) The web service produces distinct SOAP exceptions for any missing or incorrect credentials. Any perceived exception at any processing step is handled by writing the file out to a client datadump folder and sending an error notification to a system administrator. If an unknown exception is encountered, then the file is sent to a suspended queue and logged in a server application log.

The web service places or “wraps” client credentials, processing instructions, and other transaction information in an <ECLG Header> element in the XML document and places the request in a processing queue. (step 108) The BizTalk Software on the host server, then pulls the request from the queue via a RealTime AIC, validates the IMS Enterprise document, and verifies the passed-in user credentials. (step 110) Any unauthorized change to data causes a SOAP exception during any of the authentication, validation, or verification processes.

The RealTime AIC copies the IMS Enterprise document and inserts it into the client SIS system database. (step 112) The client SIS system generates and passes a tracking identifier to the RealTime AIC after successful insertion of the IMS document copy. (step 114) The RealTime AIC passes the tracking identifier back to the web service, which forwards it back to the client system via an HTTPS response. The CMS system proceeds with processing queued requests (step 116), whether real time, or bulk, etc. For example, the host server continues to process the client SIS system request (e.g., XML document) by automatically creating, retrieving, importing, exporting or updating the appropriate data as requested. The system tracks request processing using the tracking identifiers described above and provides system users access to a status indicator window to view the estimated processing time remaining for a given request.

Once processing is sufficiently completed, the processed document (including the requested information or a summary of the requested action) is returned to the requesting client. One embodiment of the invention provides means to retrieve processed enterprise documents with success/failure comments. A user may use FTP to access a client datadump folder and submit a tracking ID to the web service server. The user may then employ a “callback” web service to receive notification from the API when the processed file is ready.

The host server automatically triggers an email notification (step 118) to appropriate users of the completed/requested action. The system provides various notifications, alerts, and responses based on predetermined events or user requests. For example, an enrollment or status change of a student in a course triggers a confirmation email message to the student and/or appropriate faculty. To accomplish this, the client or host system retrieves the student email address from the student record in the SIS or CMS and delivers a message via an email engine/application containing preset text corresponding to the action taken. The default notification texts may be established in an email application (e.g., RocBox produced by ecollege) and associated with particular user or system actions. Email messages requesting a user response may be periodically sent according to a persistence routine until the requested action has been performed. The API further provides users and institutions reports and/or request response logs in an XML document containing information about, for example, the nature, number, success, and reasons for any failure of user requests.

The API architecture is designed to provide various cross system/application features as well as programming flexibility to customize or supplement these features. The API provides single sign-on capabilities, whereby users may login at any given application and have access to other integrated or associated applications without the subsequent need to log in during a given session. Single sign-on is accomplished by passing user credentials stored on the SIS and/or CMS system between the requested applications.

In one embodiment, the API allows system administrators to create new system user profiles, including specification of user roles and enroll-able nodes. For example, an administrator may add an existing user to a course or course node and specify the user's role type or role status for a given course or node. Nodes represent groups of courses, users, and the like, associated by a shared or other relevant characteristic. Enroll-able nodes are the nodes with which a given user may be associated. For example, a new instructor user may be enroll-able in the node corresponding to an appropriate course, department, or college. Users may subscribe to or be assigned to multiple enroll-able nodes, for example, to nodes for both a selected major and minor. Exemplary system role types include: System Administrator, System Support, Creator, Account Administrator, User, Administrator, and None. Institutional role types include: Student, Faculty, Member, Learner, Instructor, Teaching Assistant, Mentor, Staff, Alumni, Prospective Student, Guest, Other, Administrator, and Observer. Other role types include: Content Developer, Member, and Manager. Exemplary user status designations include: admission pending, waitlisted, matriculated, dropped, auditing, pass/fail, and enrolled. Similarly, users may be associated with or enrolled in multiple nodes, for example, multiple programs, courses, minors, committees, and the like. Any number or combination of user roles and user statuses may be associated with a given user. System administrators can use the API to change or update user roles or profiles simultaneously across multiple applications. One of skill in the art will appreciate that any user information (e.g., demographics) or properties (e.g., system authorizations, passwords) may also be automatically or manually generated, input, imported, exported, synchronized, accessed and/or updated through any number of API integrated or associated systems or software applications.

Exemplary user demographic information includes a user's name, address, telephone number, residency, social security number, citizenship, parent or spouse information, email address, age, gender, disability, birth date, employer information, major, minor, and the like. Any known data security or privacy measure now known or later developed in the art may be employed to maintain sensitive user information confidential within the system. Virtual Private Network (“VPN”) and file encryption are two common examples of available privacy measures.

The API validates submitted new user data by verifying that no conflicting data exists within any integrated or associated applications. The system then generates an email notification to the user, including user profile information such as user ID, user password and nodes in which the user is enrolled. Data validation and email notification may be performed in connection with any of the system features or functions described herein. The system further includes auditing features such as logging of each transaction (action and data) and outcome (success or failure), and archival of related XML documents for a fixed period.

In one embodiment, client users may create and update data initially in the client SIS system which is then automatically synchronized with the host CMS system. For example, course shells or entire course duplicates are automatically requested and created at the host CMS server as soon as a course or shell is created and/or activated in the client SIS. In an alternative embodiment, client system administrators use the API to create or update user profiles, course information and other data first in the client CMS system and to then synchronize this data with the client SIS system. The later process is particularly helpful if the client SIS system is unreliable or less robust. During scheduled or requested synchronization, the API automatically identifies and extracts new students from the SIS and CMS, updating the corresponding records in each system according to system defaults or user instructions. Users may specify a date range, user role, course, semester, node or combination of these and/or similar attributes to limit the scope of data extraction or synchronization for a given data request. For example, the API may be used to identify and extract enrollment changes (i.e., add, drop), performance data (i.e., pass, fail, grade) and user property changes (i.e., name, address, email, password). A user's status may also be changed by administrators to allow users already enrolled in courses full access to a course (e.g., changing a user's status from Pending to Student) or to deny users access to a course (e.g., changing from enrolled to dropped). The API carries out, logs and reports requested user status changes.

Various user requests and associated workflow steps are now described according to one embodiment. New user profiles are created, for example, when an institution admits a new student, when a professor offers his or her first online course, or when an admitted student enrolls in his or her first course. When a user first enrolls in a course or a professor offers a course in a new term, the client SIS enrolls or associates the user with the course. For example, when a student or administrator creates a new user record in the client SIS system, a request is automatically sent to the API to create a corresponding record in the host system database. The API verifies institution data and checks that required fields are complete (e.g., name, login ID, email, client node string, node role ID) and in the proper format. For example, the API verifies that submitted email addresses and proposed user IDs do not contain any invalid characters and are not already associated with an existing user. The API also verifies that submitted client node strings are associated with valid enroll-able nodes or course call numbers within the institution and that a specified role ID is valid. Additional security or verification measures include, for example, verifying that the user has a valid university enrollment for the node including the course and that the student is not already enrolled in a given course. The new user is then associated with the specified node ID. As with other system requests, a success notification is then generated and delivered to the appropriate user.

If any of the submitted data is not valid or is not in the proper format, the API rejects the transaction and delivers an error message or alert stating the defect. For example, a message window may indicate that one or more required fields are missing or that a supplied Login ID already exists. Alternatively, the API may present users the option of proceeding despite a particular error, for example, despite a failure to supply an email address. The system may be set to overwrite existing data only with valid new data. For instance, any number of existing user profile data fields or properties may be updated, with the system excluding any improperly formatted update data, while preserving the corresponding original user data.

Various user node role IDs and course IDs are periodically updated in the system, for example when a student is accepted, suspended, fails to pay tuition, withdraws, drops a class or graduates. The user status is changed first in the client SIS system, and a user profile update request is automatically sent to the API during synchronization between the SIS and the CMS. During automatic or manual synchronization, the API locates the appropriate user record, verifies the submitted data (e.g., client node string and node role ID) and enrolls the user in the designated nodes. If an incorrect new user ID is submitted during the update user profile procedure, the system may prompt the user to enter a corrected user ID or to initiate new user creation and initial node enrollment functions.

To retrieve a data set, a user such as a system administrator sends or schedules a request to the API to retrieve the relevant data sets (e.g., all new users). The API locates and verifies the institution client ID, validates any required and optional field entries or parameters, locates the requested data (e.g., all new users or enrollments based on specified parameters), and returns the data (e.g., new user/enrollment list) to the client. If no data matches the specified parameters, the API returns a “No matches found” message.

In one exemplary API process, an administrator requests export of final student grade listings from the CMS to import them into the SIS for final term reporting. Grade listings may be exported in any desired format. Administrators may further export user activity summaries, for example, reports on student attendance for financial aid, scholarship and other reporting purposes; or reports on faculty attendance for contract obligations. Administrators may similarly import extended user properties that are not otherwise supported by a standard parser, such as “degree-seeking” or “military-status” indicators corresponding to tuition and technology fee amounts. Extended user properties are associated with a user in the system and are mapped appropriately so as to be reportable and exportable.

Administrators may test a course file or user API process files against production or source information to ensure that file format and content is accurate prior to automating the file exchange process between the SIS and the host CMS server. During such tests, the API verifies file contents against production data and provides error messages showing any format or file content errors.

In one embodiment, the system allows for use of flat file formats with FTP (with optional VPN for security) to transfer CSV files for batch processing. This simple file format includes basic data such as, for example, a user's first name, last name, username, password, email, and enrollment details. While flat file formats support only batch processing, batches may be scheduled to run frequently (e.g. several times a day).

Any number of additional data management features, now known or later developed, may be incorporated into the present system without departing from the invention as described herein. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention.

1. A data exchange management system comprising:
a course management system;
a student information system; and,
an application programming interface supporting at least one of data import, export, and synchronization capabilities between said course management system and said student information system; wherein said at least one of data import, export, and synchronization capabilities is automatically invoked by said application programming interface upon detection of a predetermined event in at least one of said course management system and said student information system.

2. The system of claim 1, wherein said predetermined event is at least one of creation of a new user ID, enrollment of a user in a course, enrollment of a user in a node, creation of a new course, and creation of a new node.

3. The system of claim 1, wherein said synchronization capability is bi-directional such that said data is submitted initially to at least one of said course management system and said student information system and said data is automatically synchronized into the other of at least one of said course management system and said student information system.

4. The system of claim 1, wherein said at least one of data import, export, and synchronization capabilities includes use of at least one of IMS Enterprise Specification 1.1 compliant XML documents and delimited flat file formats.

5. The system of claim 1, wherein said application programming interface is configured to facilitate at least one of testing capabilities for verifying process file contents against production data and provide error messages related to format or file content errors.

6. The system of claim 1, wherein said application programming interface supports at least one of batch flat-file processes, XML processes and web services processes.

7. The system of claim 1, wherein said application programming interface supporting said at least one of data import, export, and synchronization capabilities is automatically invoked to pass data related to at least one of user profiles, user properties, enrollment, enroll-able nodes, user status, course properties, grades, course catalogs, user activity, and user roles.

8. The system of claim 1, wherein said application programming interface provides for selection of at least one of real-time batch processing support and asynchronous batch processing support for said at least one of data import, export, and synchronization capabilities.

9. The system of claim 1, wherein said application programming interface supports a single sign-on capability.

10. The system of claim 1, wherein said application programming interface supports a single sign-on capability between multiple software applications by passing user credentials.

11. A method for facilitating an exchange of data comprising:
wrapping an application programming interface module stored on a host course management system in XML elements to create a wrapped API module;
establishing a communication channel between a client student information system and said host course management system; and
exposing said wrapped API module to said client student information system to facilitate at least one of an automated data import, export, and synchronization process between said client student information system and said host course management system.

12. The method of claim 11, further comprising automatically invoking said exposed application programming interface module to at least one of import, export, and synchronize data between said client student information system and said host course management system, said data relating to at least one of creation of a new user profile, enrollment of a new user, duplication of a course, modification of course properties, export of a course listing, export of attendance data, and export of final grades.

13. The method of claim 12, further comprising submitting a request to enroll a new user in a course and automatically resubmitting a failed request to enroll a new user in a course for at least one of a predetermined number of attempts and a predetermined period.

14. The method of claim 11, further comprising creating at least one of a status of said at least one of an automated data import, export, and synchronization process and a time remaining to complete said at least one of an automated data import, export, and synchronization process.

15. The method of claim 11, further comprising generating an automated email notification to confirm said at least one of an automated data import, export, and synchronization process.

16. The method of claim 11, wherein the step of exposing said application programming interface modules further comprises exposing at least one of a virtual directory and a web service method.

17. The method of claim 11, further comprising generating a process export response to export an XML enterprise document with comments.

18. The method of claim 11 further comprising exporting requested data to a spreadsheet file.

19. A method for facilitating an exchange of data comprising:
generating, by a client student information system, a process request and sending said process request to a host course management system;
transmitting batch flat-files to an FTP file on said host course management system;
translating said FTP file into an XML document; and
transmitting said XML document to an application programming interface;
adding requested process data to said XML document; and,
transmitting said XML document with said requested process data to said client student information system.

20. A web services method for facilitating an exchange of data between a student information system and a course management system comprising:
automatically generating a student information system process request in the form of an XML enterprise document to a course management system host server in response to at least one of a submission of a new user record, enrollment of a user in a course, and addition of a user to an enroll-able node, said process request including a transaction tracking identifier and user credentials;
calling a web service;
passing said XML enterprise document including said user credentials embedded in a header;
authenticating said student information system process request by extracting said user credentials from said header and calling said student information system to verify said user credentials;
copying said XML enterprise document;
inserting said XML enterprise document in a student information system database; and,
relaying a tracking identifier from said web service to said student information system.

21. The method of claim 20, wherein said step of relaying a tracking identifier is completed via at least one of an HTTPS response and an FTP response.
